(19) United States
(12) Patent Application Publication
(10) Pub. No.: US 2009/0258151 A1
(43) Pub. Date: Oct. 15, 2009

(54) Method and Apparatus for Coating Curved Surfaces

(75) Inventors: Daniel B. Mitchell, Port McNicoll (CA); Geoffrey G. Harris, Midland (CA); Douglas J. Brown, Midland (CA)

Correspondence Address: HAYNES AND BOONE, LLP;IP Section, 2323 Victory Avenue, Suite 700, Dallas, TX, 75219, US

(73) Assignee: RAYTHEON COMPANY, Waltham, MA (US)

(21) Appl. No.: 12/101,012

(22) Filed: Apr. 10, 2008

(51) Int. Cl. B05D 1/02; B05B 13/02

(52) U.S. Cl. 427/424; 118/320

(57) ABSTRACT

A coating apparatus includes support structure supporting a workpiece support member for rotation about an axis, and a drive structure for rotating the support member. A source is spaced along an imaginary line from the support structure, and emits a plume of coating material that flows away from the source toward the support structure. The axis extends at an angle with respect to an imaginary plane perpendicular to the imaginary line. According to a different aspect, a coating method includes rotating a workpiece support member about an axis, and emitting a plume of coating material from a source that is spaced along an imaginary line from the support structure, the plume flowing away from the source toward the support structure. The axis extends at an angle to an imaginary plane that is perpendicular to the imaginary line.

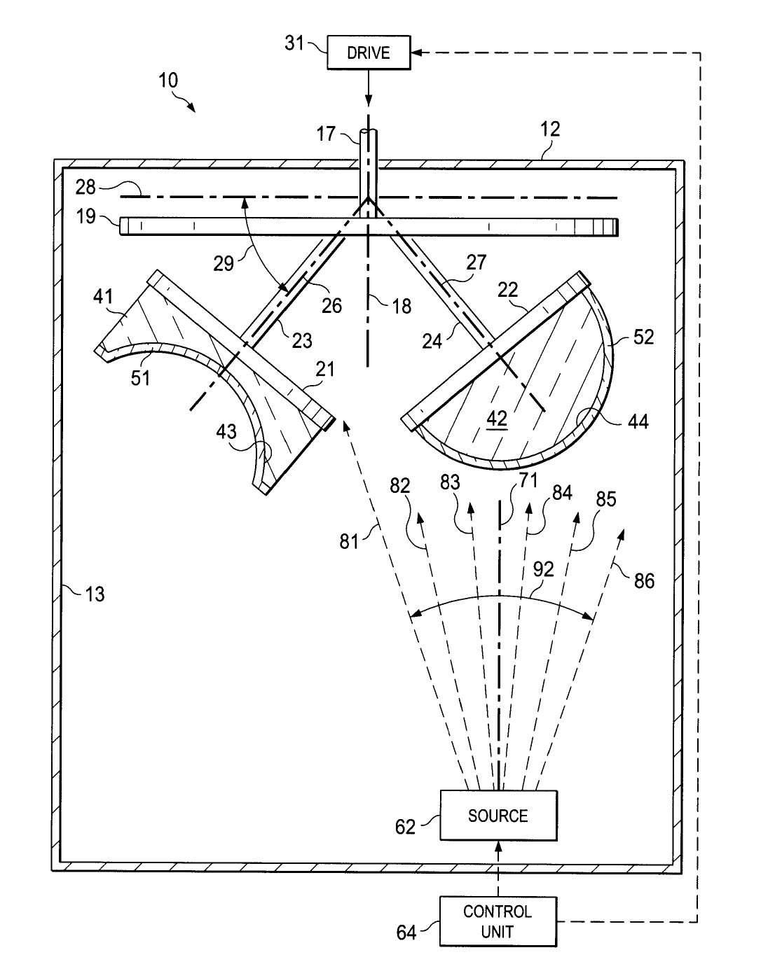

### FIELD OF THE INVENTION

This invention relates in general to techniques for coating surfaces and, more particularly, to techniques for coating curved surfaces.

### BACKGROUND

When fabricating optical components such as lenses, it is very common to form a coating on a surface of the component, where the coating provides desired optical or physical properties. For example, the coating may provide an anti-reflective (AR) characteristic, a filtering characteristic, physical protection for the component, some other characteristic, or a combination of two or more characteristics. These coatings often include multiple layers of different materials that collectively provide the desired characteristic(s).

One problem with conventional coating techniques is that any given layer in a coating may have a thickness that is not uniform throughout the layer. For example, where a coating is on a relatively highly curved surface, it is not unusual for a given layer of the coating to have a peripheral region that is as much as 30% to 50% thinner than a central region of that layer, or even more than 50% thinner. The reduced thickness in the peripheral region can result in a mechanical failure in the peripheral region of a layer. In the case of a highly curved surface, the coating material often arrives at peripheral regions of the surface with a glancing incidence, rather than perpendicular to the surface, and this is believed to also contribute to mechanical failure.

In the case of an optical component, variations in the thickness of a coating layer can affect the optical performance of the coating. For example, if coating is designed to pass light from a 1064 nm laser, it may do so in its central region where the thicknesses are correct. But a 35% thickness variation in the peripheral region can cause a corresponding variation in the wavelengths passed in the peripheral region, such that the peripheral region passes wavelengths of about 676 nm to 709 nm, rather than 1064 nm.

A further consideration is that different layers in the same coating often have different variations in thickness. For example, one layer may be 30% thinner in a peripheral region than in a central region, while another layer may be 50% thinner in the peripheral region than in the central region. Consequently, the ratios of thicknesses of different layers in the peripheral region can be different from the ratios of the thicknesses of those same layers in the central region.

Thus, even assuming that the layers of a coating all have the proper thicknesses and ratios of thickness in the central region, the thicknesses and the ratios of thicknesses in the peripheral region will typically not be correct. As a result, the coating may provide desired characteristics in the central region, but may fail to provide these desired characteristics in the peripheral region, or may at least exhibit a degradation of the desired characteristics in the peripheral region.

### BRIEF DESCRIPTION OF THE DRAWINGS

A better understanding of the present invention will be realized from the detailed description that follows, taken in conjunction with the accompanying drawing, which is a diagrammatic sectional side view of a coating apparatus that embodies aspects of the present invention.

### DETAILED DESCRIPTION

The drawing FIGURE is a diagrammatic sectional side view of a coating apparatus 10 that embodies aspects of the present invention. The coating apparatus 10 includes a housing 12 with a chamber 13 therein. The housing 12 supports a primary axle 17 for rotation about a vertical primary axis 18. A support part 19 is supported on the axle 17 for rotation with the axle about the axis 18. In the disclosed embodiment, the support part 19 is disk-shaped, but it could alternatively have any other suitable shape.

The support part 19 rotatably supports two workpiece support members 21 and 22. In this regard, two additional axles 23 and 24 are each rotatably supported on the support part 19. These additional axles are spaced circumferentially from each other about the primary axle 17, and each rotate about a respective additional axis 26 or 27. The two support members 21 and 22 are each supported on a respective one of the axles 23 and 24, for rotation therewith about the associated axis 26 or 27. The axes 26 and 27 each extend at an angle 29 with respect to an imaginary plane 28 that is perpendicular to the vertical axis 18. The angle 29 is within a range of approximately 20° to 70°, and preferably within a range of approximately 35° to 55°. In the disclosed embodiment, the angle 29 happens to be about 45°. But in practice, the angle 29 will be selected in dependence on various factors, such as the curvature of the surface to be coated, whether the surface is concave or convex, the geometry of the coating chamber 13, and so forth. In the disclosed embodiment, the support members 21 and 22 are each disk-shaped, but they could each alternatively have any other suitable shape.

In the disclosed embodiment, the axes 26 and 27 are each oriented so that they intersect the vertical axis 18 at a common, not-illustrated point. Alternatively, however, the axes 26 and 27 could be oriented so that they intersect the axis 18 at different points, or so that they are skewed with respect to the axis 18 and do not intersect it at all.

Although the drawing FIGURE shows two workpiece support members 21 and 22 that are supported by respective axles 23 and 24, it would alternatively be possible to have one or more further workpiece support members that each have an axle, where all of the additional axles are spaced circumferentially from each other about the primary axle 17.

A drive mechanism 31 such as electric motor is coupled to the axle 17, in order to effect rotation of the axle 17 and the support part 19. A not-illustrated planetary gearing mechanism of a well-known type is provided and, in response to rotation of the support part 19 with respect to the housing 12, effects rotation of the additional axles 23 and 24 with respect to the support part 19. Thus, the workpiece support members 21 and 22 each undergo planetary movement about the primary axis 18 with respect to the housing 12. The primary axle 17, the support part 19, the additional axles 23 and 24, and the workpiece support members 21 and 22 collectively serve as a workpiece support mechanism.

Each of the workpiece support members 21 and 22 is configured to removably support a respective workpiece 41 or 42. The workpieces 41 and 42 each have, on a side thereof opposite from the support member 21 or 22, a relatively highly curved surface 43 or 44. The apparatus 10 is used to form respective coatings 51 and 52 on the respective curved surfaces 43 and 44 of the workpieces 41 and 42, in a manner discussed in more detail later. The surfaces 43 and 44 are equivalent to surfaces that would be swept out by rotating a segment of an arc or curve about the axis 26 or the axis 27. Thus, the axis 26 extends through a central region of the surface 43 and a central region of the coating 51, and the axis 27 extends through a central region of the surface 44 and a central region of the coating 52.

In the drawing FIGURE, the curved surface on workpiece 41 is concave, and the curved surface 44 on workpiece 42 is convex. This visually demonstrates that the coating apparatus 10 is suitable for use with a variety of different surface shapes, including both concave and convex surfaces. As a practical matter, during an actual coating operation, the workpieces in the coating apparatus 10 would typically be identical or very similar, and would thus have curved surfaces that are identical or very similar.

The coating apparatus 10 is not limited to use for coating highly curved surfaces, and in fact can be used to coat surfaces having a variety of different shapes. However, the coating apparatus 10 is very effective when used to coat highly curved surfaces, such as those shown at 43 and 44.

In the disclosed embodiment, the workpieces 41 and 42 with the coatings 51 and 52 thereon are each an optical component of a type well known in the art, such as a lens. They are therefore described here only briefly, to the extent necessary to facilitate an understanding of the structure and operation of the coating apparatus 10. Further, it should be understood that the coating apparatus 10 is not limited to use for coating optical components, but can alternatively be used for coating a wide variety of other types of workpieces. In the disclosed embodiment, since the workpieces 41 and 42 are each an optical component, they each have an optical axis, and the optical axis of each is coincident with the associated axis 26 or 27. However, it is not a requirement that optical workpieces have their optical axes aligned with their rotational axes.

It would be possible for each of the coatings 51 and 52 to be only a single layer of a single material. But in the disclosed embodiment, the coatings 51 and 52 each include a plurality of different layers, involving the use of one material for some layers, another material for other layers, and so forth. By interleaving different layers of different materials in a known manner, the coatings 51 and 52 can each be given certain desired optical characteristics. For example, the coatings 51 and 52 may each be anti-reflective (AR) coatings that provide little or no reflection of a selected range of wavelengths, such as a range corresponding to visible light.

In some cases, the multi-layer coatings 51 and 52 will be configured in a known manner to provide a combination of two or more desired optical characteristics. For example, a given coating may provide an AR characteristic as to one range of wavelengths, such as visible light, while also filtering out wavelengths in a different range, such as a range associated with laser energy.

As another example, if the optical workpiece 41 or 42 happens to be made of a relatively soft material that was selected because it provides certain desirable optical properties, the coating 51 or 52 thereon may be configured to be physically harder than the associated workpiece 41 or 42, in order to help physically protect the material of the workpiece 41 or 42. Thus, a given coating 51 or 52 may provide an AR characteristic, while also being physically harder than the material of the workpiece 41 or 42, in order to help physically protect the workpiece. The discussion here of AR characteristics, filtering characteristics and hardness characteristics is merely exemplary. The coatings 51 and 52 may each provide some or all of these characteristics, and/or any of a variety of other characteristics, separately or in combination.

In the multi-layer coatings 51 and 52, the layers may all have the same thicknesses, or some layers may be intentionally be thicker than other layers. Ideally, it is desirable that the thickness of each layer be relatively uniform throughout the layer. In comparison to pre-existing coating systems, the disclosed coating apparatus 10 is configured to achieve significantly better uniformity of the thickness of each layer within the coatings 51 and 52.

The coating apparatus 10 includes a source 62 in a lower portion of the housing 12. The source 62 is spaced from the support part 19 along an imaginary vertical line 71. Although the drawing FIGURE shows only a single source 62, it would alternatively be possible to provide two or more sources in the apparatus 10. In the disclosed embodiment, the source 62 is spaced radially from the primary axis 18, and is positioned approximately below the path of travel of the workpiece support members 21 and 22. Alternatively, however, it would be possible for the source 62 to be positioned at any of a variety of other locations within the housing 12. The source 62 and the drive mechanism 31 are both controlled by a control unit 64.

The source 62 is a device of a type well known in the art, and is therefore described here only briefly. In the disclosed embodiment, the source 62 is a type of device commonly referred to as an electron beam evaporator. However, the source 62 could alternatively be any other suitable type of device. The source 62 contains two or more different materials that will be used to form respective layers in each of the multi-layer coatings 51 and 52, and the source can selectively evaporate any of these different materials. At any given point in time, the source 62 will typically be evaporating only one of the multiple different materials that it contains. But in some situations, the source may simultaneously evaporate two or more of the different materials.

In a coating formed by a pre-existing coating system, each layer in the coating is often thinner in its peripheral region than in its central region, especially when the coating is formed on a highly curved surface. For example, it is not unusual for a given layer to have a peripheral region that is as much as 30% to 50% thinner than a central region of that same layer, or even more than 50% thinner. Consequently, in a pre-existing coating, the various different layers could all have the desired thicknesses and the desired ratios of thicknesses in the central region of the coating, but these same layers could have reduced thicknesses and different ratios of thicknesses in the peripheral region of the coating. As a result, the central region of the coating could accurately provide desired optical characteristics (such as filtering or anti-reflection), whereas the peripheral region of the same coating might fail to provide these optical characteristics, or might provide them with reduced performance.

With reference to the disclosed coating apparatus 10, when the source 62 is evaporating a material, a plume of the evaporated material travels upwardly, as indicated diagrammatically by arrows 81-86. The plume 81-86 from the source 62 basically coats the surfaces 43 and 44 on the workpieces 41 and 42 as the workpieces pass directly above the source 62. Due to the fact that the axles 23 and 24 each extend downwardly and outwardly at an angle with respect to the vertical axis 18, as the workpieces rotate about their respective axes 26 and 27, coating material is deposited relatively uniformly on the curved surfaces 43 and 44, from the central region to the peripheral region of each surface. Moreover, even where the plume 81-86 happens to have a relatively wide dispersion angle 92, a peripheral portion 81 of the plume will tend to pass between the workpiece supports 21 and 22, without contacting workpieces that are not currently passing above the source 62. This also helps to avoid undesired thickness variations.

When coating highly curved surfaces, pre-existing coating systems deposit layers with thickness variations that typically average about 35%. In contrast, when coating highly curved surfaces, the disclosed coating apparatus 10 can deposit layers with thickness variations that average only about 3%. Due to this reduction in thickness variations, the resulting coatings have layers that are relatively uniform in thickness across the entire curved surface, and that have about the same thickness ratios in both the central region and the peripheral region of the coating. Accordingly, in the case of an optical component with an optical coating, the optical characteristics of the coating are very uniform in both the central and peripheral regions of the coating. Further, the layers of the coating have improved mechanical properties, with reduced susceptibility to mechanical failure.

Although a selected embodiment has been illustrated and described in detail, it should be understood that a variety of substitutions and alterations are possible without departing from the spirit and scope of the present invention, as defined by the claims that follow.

What is claimed is:

1. An apparatus comprising;
a workpiece support member;
support structure supporting said support member for rotation about a support member axis;
drive structure cooperable with said support structure for effecting rotation of said support member about said support member axis; and
a source that is spaced along an imaginary line from said support structure, and that can emit a plume of coating material that flows away from said source toward said support structure, said support member axis extending at an angle with respect to an imaginary plane perpendicular to said imaginary line.

2. An apparatus according to claim 1, wherein said angle is in the range of approximately 20° to 70°.

3. An apparatus according to claim 2, wherein said angle is in the range of approximately 35° to 55°.

4. An apparatus according to claim 3, wherein said angle is approximately 45°.

5. An apparatus according to claim 1, including a workpiece that is fixedly supported on said support member and that has a curved surface oriented to be coated by coating material from said source, said curved surface having a central region and said support member axis extending through said central region of said surface.

6. An apparatus according to claim 5, wherein said curved surface has a shape corresponding to rotation of a two-dimensional curve about said support member axis.

7. An apparatus according to claim 5, wherein said workpiece is an optical part having an optical axis, said workpiece being supported on said support member so that said optical axis is substantially coincident with said support member axis.

8. An apparatus according to claim 1,
wherein said support structure supports said support member for rotation about a further axis that extends approximately perpendicular to said imaginary plane; and
wherein said drive structure is cooperable with said support structure for effecting rotation of said support member about said further axis.

9. An apparatus according to claim 8, wherein said support member is spaced radially from said further axis.

10. An apparatus according to claim 8, including a plurality of further workpiece support members each supported by said support structure for rotation about a respective further support member axis that is inclined with respect to said imaginary plane, said support members being radially spaced from and provided at circumferentially spaced locations about said further axis, and said drive structure being cooperable with said support structure for effecting rotation of each of said support members about the corresponding support member axis and about said further axis, such that each said support member carries out approximately planetary movement about said further axis.

11. An apparatus according to claim 10, wherein said support member axes are each oriented to intersect said further axis at approximately the same point.

12. An apparatus according to claim 10,
wherein said support structure includes a support part supported for rotational movement with respect to said source about said further axis; and
wherein said support members are each supported on said support part for rotational movement with respect thereto about a respective one of said support member axes.

13. An apparatus according to claim 12, including a plurality of workpieces that are each fixedly supported on a respective said support member, and that each have a curved surface oriented to be coated by coating material from said source.

14. A method comprising;
supporting a workpiece support member for rotation about a support member axis;
rotating said support member about said support member axis; and
emitting from a source that is spaced along an imaginary line from said support structure a plume of coating material that flows away from said source toward said support structure, said support member axis extending at an angle with respect to an imaginary plane perpendicular to said imaginary line.

15. A method according to claim 14, including selecting said angle to be in the range of approximately 20° to 70°.

16. A method according to claim 15, including selecting said angle to be in the range of approximately 35° to 55°.

17. A method according to claim 16, including selecting said angle to be approximately 45°.

18. A method according to claim 14, including supporting on said support member a workpiece that has a curved surface oriented to be coated by coating material from said source, with an orientation so that said support member axis extends through a central region of said curved surface.

19. A method according to claim 18,
including configuring said workpiece to be an optical part having an optical axis; and
wherein said supporting of said workpiece on said support member includes orienting said workpiece so that said optical axis is substantially coincident with said support member axis.

20. A method according to claim 14,
including supporting said support member for rotation about a further axis that extends approximately parallel to said imaginary line; and
rotating said support member about said further axis.

21. A method according to claim 20, including positioning said support member at a location spaced radially from said further axis.
